(19) United States
(12) Patent Application Publication
(10) Pub. No.: US 2004/0253393 A1
(43) Pub. Date: Dec. 16, 2004

(54) Binder to improve light fastness for inkjet photo media

(76) Inventor: Bor-Jiunn Niu, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/460,242

(22) Filed: Jun. 11, 2003

(51) Int. Cl. B41M 5/00

(52) U.S. Cl. 428/32.24

(57) ABSTRACT

Image permanence is always one of the most important attributes for thermal inkjet photo media. Currently, polyvinyl alcohol, cellulose and gelatin are the most common binders that have been used in inkjet media development. Both polyvinyl alcohol and cellulose do not provide very good image permanence. Gelatin does provide an excellent image permanence, but gelatin has severe curl problems at cold and dry conditions. Therefore, to find or develop a new binder to provide good image permanence and humid fastness is an important focus. The use of water-soluble polyvinyl acetal can provide not only the good light fastness and humid fastness on inkjet prints but also minimize the curl and stiffness issues at cold and dry conditions.

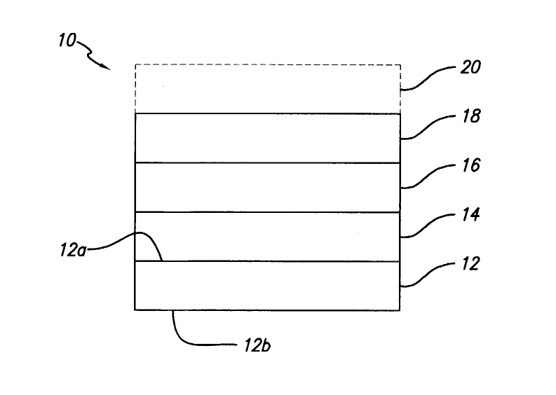

### TECHNICAL FIELD

The present invention is generally directed to media products for receiving printed images thereon, and, more particularly, to image-receiving sheet materials each having at least one ink-receiving layer having improved light fastness.

### BACKGROUND ART

Substantial developments have been made in the field of electronic printing technology. A wide variety of highly-efficient printing systems currently exist which are capable of dispensing ink in a rapid and accurate manner. Thermal inkjet systems are especially important in this regard and have enjoyed commercial success.

In order to effectively generate printed images using the various ink transfer techniques and systems discussed herein (again, with primary but not exclusive reference to thermal inkjet technology), ink-receiving print media materials must be employed which are capable of efficiently accomplishing this goal. Ideally, to achieve maximum efficiency, print media materials should be able to provide numerous advantages and benefits including but not limited to (1) a high level of light-fastness, with the term “light-fastness” being generally defined herein to involve the capacity of a print media product to retain images thereon in a stable fashion without substantial fading, blurring, distortion, and the like over time in the presence of natural or made-made light; (2) rapid drying times in order to avoid smudging and image deterioration immediately after printing is completed due to contact with physical objects and the like; (3) the fast and complete absorption of ink materials in a manner which avoids image distortion caused by color bleed (e.g. the undesired migration of multi-colored ink components into each other) and related difficulties; (4) a highly water-fast character (with the term “water-fast” being generally defined to involve the ability of a print media product to produce a stable image with little or no fading, run-off, distortion, and the like when the image is placed in contact with moisture); (5) the generation of “crisp” images with a distinct and defined character; (6) the ability to produce printed products which are substantially “smear-fast”, with this term being generally defined to comprise the production of images that will not exhibit smearing, blurring, and the like when rubbed or otherwise physically engaged with a variety of objects ranging from the components of the printing apparatus being employed to the print operator's hands, fingers, and the like; (7) the control of an undesired condition known as “ink-coalescence” which is defined herein to involve a phenomenon wherein wet ink droplets applied to an inkjet printing medium fail to spread sufficiently to eliminate the unprinted space between the droplets, thereby causing significant image deterioration problems; (8) the capacity to generate printed images with desired levels of gloss wherein the final product is characterized by uniform gloss levels throughout the entire image in order to achieve a professional and aesthetically-pleasing printed media sheet; (9) low material costs which enable the print media products of interest to be employed for mass market home and business use; (10) chemical compatibility with a wide variety of ink formulations which leads to greater overall versatility; (11) excellent levels of image stability and retention over long time periods; (12) minimal complexity from a production and material-content standpoint which leads to reduced fabrication costs and greater product reliability; and (13) a high level of gloss-control which is achievable in a rapid and effective manner during production through only minor adjustments in the manufacturing process. The term “gloss-control” is generally defined herein to involve the ability, during fabrication, to generate a print media product having high-gloss levels for the production of photographic quality images if desired, a semi-gloss character if needed, or other gloss parameters. In particular, the manufacturing process should be highly controllable in order to achieve a variety of different gloss characteristics without requiring major adjustments in processing steps and materials.

In the past, many different print media sheets using a wide variety of ingredients, production techniques, layering arrangements, and the like have been fabricated for a multitude of specific purposes. For example, the following items have been investigated and/or employed in the production of print media products to achieve a broad spectrum of goals: modifications in the types of materials being used, the amounts of such materials, the relative particle sizes thereof, the particular layering arrangements being chosen, and the adjustment of various factors including pore size, pore volume, layer thickness, particle orientation, surface roughness, surface rigidity, air permeability, and other similar parameters.

Light fastness and humid fastness are two of the most challenging aspects with photo media used in color inkjet printers. By “photo media” is meant print media of photographic or near-photographic quality. Such photo media usually have at least one ink-receiving layer and a top coating.

To maintain good light fastness and humid fastness for photo media in inkjet printers, gelatin and other polymeric binders have been used. However, a multi-layer coating technology is utilized to manufacture the photo media, including the ink-receiving layer and the top layer. Since the polymeric binder is the major binder used in the top coat, it has not been possible to date to provide the best solution for humid fastness and light fastness with current design due to the poor intrinsic associations between dye and PVOH binder.

Notwithstanding the various media products already known in the prior art, a need remains for print media materials (namely, ink-receiving sheets) that include improvements in the afore-mentioned benefits. More specifically, an increase in light fastness is especially desired.

### DISCLOSURE OF INVENTION

In accordance with the embodiments disclosed herein, a water-soluble polyvinyl acetal is employed as part or all of the binder in the ink-receiving layer, resulting in a significant improvement in both light fastness and humid fastness.

In particular, a method is provided for improving at least the light fastness of ink jet photo media comprising a substrate, at least one ink-receiving layer thereon, and, optionally, a top protective coat on the uppermost ink-receiving layer, said at least one ink-receiving layer comprising at least one pigment and at least one binder, said method comprising either formulating said at least one binder to include water-soluble polyvinyl acetal or forming a layer of said water-soluble polyvinyl acetal under said at least one ink-receiving layer.

### BRIEF DESCRIPTION OF THE DRAWINGS

The sole FIGURE depicts the structure of an embodiment of the print media employed herein.

### BEST MODES FOR CARRYING OUT THE INVENTION

Reference is made now in detail to specific embodiments, which illustrates the best mode presently contemplated by the inventor for practicing the invention. Alternative embodiments are also briefly described as applicable.

Print media conventionally include a substrate, one or more ink-receiving layers thereon, in stacked sequence if there are two or more such layers, and, optionally, a top protective coat or layer. The sole FIGURE shows a print media 10 comprising a substrate 12, on which is formed an underlayer 14. A supporting layer 16 is formed on the underlayer 14. An image layer 18 is formed on the supporting layer 16. An optional top protective layer 20 is formed on the image layer 18.

In order to produce a preferred print media product 10 in accordance with the embodiments herein, a support structure, “support”, or “substrate” 12 (with all of such terms being considered equivalent from a structural and functional standpoint) is initially provided on which the other layer or layers associated with the print media product reside. Many different construction materials can be employed in connection with the substrate including those that are made from paper, plastics, metals, or composites of such materials without limitation, although paper (any commercially-available type) is preferred. The chosen substrate 12 may be coated or uncoated on either or both sides thereof. In a preferred embodiment designed to provide optimum results, the substrate includes an upper surface 12a (also characterized herein as a “first side”) and a lower surface 12b (also characterized herein as a “second side”), with at least one of such surfaces/sides (preferably the upper surface or both surfaces) being covered with a substantially non-porous, non-absorbent, and ink-impermeable composition in the form of an underlying coating layer 14. A representative and exemplary coating composition associated with this embodiment involves polyethylene when a paper substrate 12 is employed. However, other coating/substrate combinations, including a supporting layer 16, can be used without limitation, or the application of substrate coatings can be eliminated entirely if desired as determined by routine preliminary pilot testing.

Positioned (e.g., provided) over and above the substrate 12 (and secured thereto with “direct attachment” being preferred but not necessarily required) is at least one “ink-receiving layer” 18. From a functional standpoint, the ink-receiving layer 18 is designed to provide a high degree of “capacity” (e.g. ink-retention capability) in connection with the media product 10, to facilitate rapid drying of the printed, image-containing media product, to create a media product with a smooth/even surface, to ensure that the desired gloss characteristics are maintained in the finished product, and to generate a stable printed image with desirable degrees of ink-coalescence control and the like. To accomplish these goals, the ink-receiving layer 18 is typically comprised of at least one binder material, which has numerous functions including but not limited to binding capabilities, ink-absorptivity, the capacity to affix and retain printed images in a highly stable manner, and the like.

The ink-receiving layer 18 typically includes about 9 to 99 wt %, and preferably 80 to 99 wt %, of at least one binder composition therein. The foregoing percentage values (and all other numerical quantities expressed herein unless otherwise noted) involve the total amount of binder compositions(s) in question, whether a single binder or multiple binders in combination are employed. Exemplary and preferred examples of these materials include, without limitation, the following: polyvinyl alcohol and derivatives thereof, starch, SBR latex, gelatin, alginates, carboxycellulose materials, polyacrylic acid and derivatives thereof, polyvinyl pyrrolidone, casein, polyethylene glycol, polyurethanes (for example, a modified polyurethane resin dispersion), polyamide resins (for instance, an epichlorohydrin-containing polyamide), mixtures thereof, and others without restriction. It should also be understood that the use of supplemental binder compositions in the ink-receiving layer 18 shall be considered optional in nature. Likewise, if multiple binder compositions are to be employed (e.g., at least two or more), a still further version of the present embodiment will involve a situation in which all of the supplemental binders being used are different from each other. For example, a mixture of (1) an epichlorohydrin-containing polyamide; and (2) a modified polyurethane resin dispersion combined with poly(vinyl alcohol-ethylene oxide) copolymer can provide favorable results.

As is well known, the ink-receiving layer 18 discussed above may further comprise one or more additional ingredients therein combined with the binder(s). For example, at least one pigment of a particulate or non-particulate character (organic or inorganic) may be employed within the ink-receiving layer. If such pigment is used, then the ink-receiving layer 18 will optimally include about 1 to 10 wt % pigment therein. Again, the foregoing percentage values (and all other numerical quantities expressed herein unless otherwise noted) involve the total amount of pigment in question whether a single pigment or multiple pigments in combination are employed. Exemplary and preferred (non-limiting) pigments suitable for use in the ink-receiving layer or layers of this invention include the following compositions, without limitation, silica (in precipitated, colloidal, gel, sol, or fumed form), cationic-modified silica (e.g., alumina-treated silica in an exemplary and non-limiting embodiment), cationic polymeric binder-treated silica, aluminum oxide, magnesium oxide, magnesium carbonate, calcium carbonate, pseudo-boehmite, barium sulfate, clay, titanium dioxide, gypsum, and mixtures thereof. It should also be understood that the use of a pigment composition or compositions in the ink-receiving layer 18 is optional.

In accordance with the teachings herein, water-soluble polyvinyl acetal is incorporated into the inkjet ink-receiving layer 18 in a multi-layer construction, partially or wholly replacing the binder, e.g., polyvinyl alcohol, therein. Alternatively, the water-soluble polyvinyl acetal binder is provided as a support layer 16 under the ink-receiving layer 18. In either case, the presence of the water-soluble polyvinyl acetal serves to provide good image permanence (light fastness) and humid fastness.

When the water-soluble polyvinyl acetal is incorporated as part of the ink-receiving layer 18, the conventional binder, e.g., polyvinyl alcohol (PVA), is partially replaced with the water-soluble polyvinyl acetal. Preferably, about 5 to 80 wt %, more preferably, 5 to 50 wt %, and most preferably 5 to 30 wt % of the PVA (or other binder) is replaced with water-soluble polyvinyl acetal.

PVA (PVOH) provides good gloss, humid fastness, light fastness, and less curl compared with other polymeric binders; however, it is still worse than gelatin in its properties other than curl. But gelatin has very strong curl deficiency that is worse than most other polymeric binders, including PVOH. The partial replacement is determined by the performance. While 100% replacement could be done, there would be other undesirable trade-offs, since the PVOH provides good image gloss and color gamut, etc.

Water-soluble polyvinyl acetal has not been readily available commercially until relatively recently.

The embodiments herein are not be restricted to any particular additional ingredients or amounts thereof, with the following representative and non-limiting additional ingredients being employable if desired: (1) at least one pigment (without any additional binder compositions); (2) at least one additional binder composition (without any pigments); or (3) at least one pigment and at least one additional binder composition in combination. It should also be noted that any or all of the foregoing variants may incorporate one or more subsidiary additives ranging from surfactants to lubricant compositions and preservatives (discussed further below) if needed and desired as determined by routine preliminary testing. Likewise, the present embodiments shall not be restricted to any particular number of ink-receiving layers 18 which contain the desired polyvinyl acetal which may range from one to multiple layers directly adjacent to each other or separated by one or more other material layers. As previously stated, it is preferred that the top/uppermost/outermost layer in the media products of the present invention involve the claimed ink-receiving layer 18 which contains at least one polyvinyl acetal. However, it is also contemplated that the ink-receiving layer or layers 18 comprised of the claimed polymer may be located anywhere on or within the print media products as needed and desired as along as such layer(s) can, in some fashion, receive all or part of the ink materials being delivered by the printer unit. All of these variations are again applicable to each of the other embodiments discussed herein as well as those that are covered by the claims set forth below.

With respect to the subsidiary additives mentioned above which are primarily designed to perform non-pigment and non-binder functions, a number of such compositions can be used as again determined by routine preliminary pilot testing. For example, these additives include but are not limited to the following materials: fillers, surfactants, lubricants, light-stabilizers, preservatives (e.g., antioxidants), general stabilizers, and the like (along with mixtures thereof) without limitation. While these additives may be contained within the ink-receiving layer 18 in variable amounts, they should again be considered optional and employed on an “as needed” basis. Furthermore, they may be used in the ink-receiving layer 18 having the claimed polyvinyl acetal polymer therein whether or not the layer also includes any pigments and/or additional binder compositions.

The ink-receiving layer 18 of interest which is designed to provide the important benefits listed above may involve many different variants without limitation provided that: (1) at least one ink-receiving layer is employed, with this layer being composed entirely or partially of one or more polyvinyl acetal polymers; and (2) the ink-receiving layer is located on or within the claimed print media product 10 so that it receives at least some of the ink materials thereon or therein which are delivered to the media product by the chosen printer unit. Accordingly, it is a novel and functionally important feature of these teachings to provide a print media product 10 which includes, at the very least, a substrate 12 and at least one ink-receiving layer 18 that is entirely or partially produced from at least one polyvinyl acetal polymer either in the layer or underneath it (as supporting layer 16), with both variants being encompassed within the scope of the claims.

The water-soluble polyvinyl acetal employed herein is based on a reaction of polyvinyl alcohol with an aldehyde:

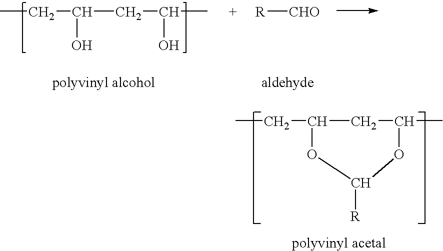

where R is alkyl.

While the above reaction assumes 100% conversion to polyvinyl acetal, in fact, there is formed a copolymer of polyvinyl acetal, polyvinyl acetyl, and polyvinyl alcohol:

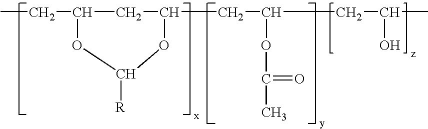

where x+y+z=100. To have a water-soluble product, the degree of acetalization (the value of x) is comparatively low, as is the hydroxyl content. Specifically, x is preferably in the range of about 0.1 to 30 mol %, and y<z. Further, R should be low, preferably 1 to 2 carbon atoms. The viscosity of the resin is on the order of about 1,000 to 6,000 mPa.s. Such water-soluble polyvinyl acetals are commercially available from Sekisui Chemical (Osaka, Japan) as S-LEC K KW polyvinyl acetal resins.

In general, to have a good water solubility for PVOH, the ratio of y/z is in the range of about 10:90 to 1:99 if it is assumed that x=0.1. So, if the x is equal to 30%, then y will be from 10% to 1% and the z will be from 60% to 69% because x (acetal segment) is increasing at the expense of z (PVOH segment). The summarized ranges for segments x, y and z are listed below:

x=0.1 to 30%

y=1 to 10%

z=9 to 99%.

### EXAMPLES

Example 1. Polyvinyl Acetal Layer under Ink-Receiving Layer.

A photo media was prepared, comprising (a) a substrate comprising photobase paper, an underlayer 14 comprising the composition listed in Table I below, a supporting layer 16 comprising water-soluble polyvinyl acetal copolymer (100%), and an image layer (ink-receiving layer) 18 comprising the composition listed in Table II below. The undercoat layer and the image layer were coated at the coating weights (g/m²) noted.

TABLE I
Composition of Underlayer 14.

| Component | wt % | |
|---|---|---|
| Gelatin | 53.2 | |
| Glycerol | 2.2 | |
| Triton X-100 | 0.2 | |
| Mowiol 2688 | 44.3 | |
| Hardener OB1207 | 0.1 | |
| Coating weight | 10 | gsm |

With regard to underlayer 14, the gelatin was photo-grade gelatin and obtained from DGF (Germany). Both Triton X-100 (a surfactant) and glycerol were obtained from Aldrich Chemicals (Milwaukee, Wis.). Mowiol 2688 is a polyvinyl alcohol and was obtained from Clariant Corporation (Charlotte, N.C.). Hardener OB1207, a pyridine-type hardener, was obtained from H.W. Sands Corporation (Jupiter, Fla.). The composition was coated with a Mayer bar on photobase paper.

The support layer 16, comprising 100% water-soluble polyvinyl acetal copolymer was formed on the above-listed underlayer 14. In this instance, the copolymer was Sekisui Chemical's S-LEC K KW-3 polyvinyl acetal resin.

The ink-receiving layer 18 was then coated on the support layer 16.

TABLE II
Composition of Ink-Receiving Layer 18.

| Component | wt % | |
|---|---|---|
| Gelatin | 19.21 | |
| Cationic polymer | 19.21 | |
| WO-320R | 47.90 | |
| Culminal MHPC 100 | 9.60 | |
| Glycerol | 1.34 | |
| Lodyne S107B | 0.96 | |
| Triton X-100 | 0.39 | |
| Surfactant 10G | 0.39 | |
| Gasil HP 39 | 1.00 | |
| Coating weight | 2.6 | gsm |

With regard to ink-receiving layer 18, the gelatin used in this example was photo-grade gelatin and obtained from DGF, Germany. The cationic polymer was a styrene-acrylic copolymer. Both Triton X-100 (surfactant) and glycerol were obtained from Aldrich Chemicals, Milwaukee, Wis., USA. WO-320R is a modified polyvinyl alcohol and was obtained from Nippon Gohsei Chemical (Osaka, Japan). Cuiminal MHPC 100, a cellulose polymer, was obtained from Hercules Incorporated (Wilmington, Del.). Lodyne S107B, a fluorine surfactant, was obtained from Ciba Specialty (Tarrytown, N.Y.). Surfactant 10G was obtained from Arch Chemicals, Inc. (Norwalk, Conn.). Gasil HP39, a silica, was obtained from INEOS Silicas Americas LLC (Joliet, Ill.). The composition was coated with a Mayer bar on the support layer 16.

The photo media was printed upon using Hewlett-Packard ink-jet 78 ink.

Light fastness was measured using ATLAS HPUV™ Indoor Actinic Exposure System, from ATLAS Material Testing Technology LLC, Chicago, Ill., USA. The “Years to Failure” was measured by extroplating the optical density changes to the failure point, and the measurement of optical density change was based on 5 years simulation time. The simulation is based on the assumption that the dose of light exposure is 400 lux per hour and the exposure time is 12 hours per day. Therefore, the total light exposure dose for 5 years is 8760 klux.

The following results were obtained, as listed in Table III below. Comparison was made to (1) a control (the same underlayer 14 and ink-receiving layers 18, but no supporting layer 16), (2) the layer compositions listed above, (3) a single layer of water-soluble polyvinyl acetal replacing the three layers (underlayer 14, supporting layer 16, and ink-receiving layer 18), and (4) a single layer of polyvinyl alcohol, again replacing the three layers (underlayer 14, supporting layer 16, and ink-receiving layer 18). In the latter two instances, the coating weight was 20 g/m² each.

TABLE III
Results of Light Fastness Testing.

| Configuration | Years to Failure |
|---|---|
| Control (no supporting layer) | 9.9 |
| Formulation listed above (three layers) | 17.1 |
| Single layer of polyvinyl acetal | 16.7 |
| Single layer of polyvinyl alcohol | 6.9 |

As can be seen, the formulation listed above and the single layer of water-soluble polyvinyl acetal show considerable light fastness improvement over the control and over the single layer of PVA.

### Example 2a

### Partial Replacement of Polyvinyl Alcohol in Ink-Receiving Layer with Polyvinyl Acetal.

In this example, 25 wt % polyvinyl (WO-320R) was replaced with water-soluble polyvinyl acetal (KW-3). The ink-receiving layer 18 had the composition listed in Table IV below. The substrate 12 and undercoat layer 14 were the same as in Example 1; there was no support layer 16.

TABLE IV
Composition of Ink-Receiving Layer.

| Component | wt % | |
|---|---|---|
| Gelatin | 19.21 | |
| Cationic polymer | 19.21 | |
| WO-320R | 35.9 | |
| Polyvinyl acetal KW-3 | 12 | |
| Culminal MHPC 100 | 9.60 | |
| Glycerol | 1.34 | |
| Lodyne S107B | 0.96 | |
| Triton X-100 | 0.39 | |
| Surfactant 10G | 0.39 | |
| Gasil HP 39 | 1.00 | |
| Coating weight | 2.6 | gsm |

Comparison of light fastness for this combination evidences an improved light fastness over that of an ink-receiving layer having PVOH and no replacement water-soluble polyvinyl acetal.

### Example 2b

### Partial Replacement of Polyvinyl Alcohol in Ink-Receiving Layer with Polyvinyl Acetal.

In this example, 75 wt % polyvinyl (WO-320R) was replaced with water-soluble polyvinyl acetal (KW-3). The ink-receiving layer 18 had the composition listed in Table V below. The substrate 12 and undercoat layer 14 were the same as in Example 1; there was no support layer 16.

TABLE V
Composition of Ink-Receiving Layer.

| Component | wt % | |
|---|---|---|
| Gelatin | 19.21 | |
| Cationic polymer | 19.21 | |
| WO-320R | 12 | |
| Polyvinyl acetal KW-3 | 35.9 | |
| Culminal MHPC 100 | 9.60 | |
| Glycerol | 1.34 | |
| Lodyne S107B | 0.96 | |
| Triton X-100 | 0.39 | |
| Surfactant 10G | 0.39 | |
| Gasil HP 39 | 1.00 | |
| Coating weight | 2.6 | gsm |

Comparison of light fastness for this combination evidences an improved light fastness over that of an ink-receiving layer having PVOH and no replacement water-soluble polyvinyl acetal.

### INDUSTRIAL APPLICABILITY

The use of polyvinyl acetal to improve light fastness is expected to find utility in the manufacture of ink jet glossy print media.

What is claimed is:

1. A method for improving at least the light fastness of ink jet photo media comprising a substrate, at least one ink-receiving layer thereon, and, optionally, a top protective coat on the uppermost ink-receiving layer, said at least one ink-receiving layer comprising at least one pigment and at least one binder, said method comprising either formulating said at least one binder to include water-soluble polyvinyl acetal or forming a layer of said water-soluble polyvinyl acetal under said at least one ink-receiving layer.

2. The method of claim 1 wherein said at least one binder has a concentration in said at least one ink-receiving layer within a range of 9 to 99 wt %, and wherein of the total binder concentration, at least 5 wt % of said total binder concentration comprises said water-soluble polyvinyl acetal.

3. The method of claim 2 wherein said at least one binder has said concentration within a range of 80 to 99 wt %.

4. The method of claim 2 wherein said at least one binder comprises less than 100 wt % of said polyvinyl acetal and further includes at least one binder selected from the group consisting of polyvinyl alcohol and derivatives thereof, starch, SBR latex, gelatin, alginates, carboxycellulose materials, polyacrylic acid and derivatives thereof, polyvinyl pyrrolidone, casein, polyethylene glycol, polyurethanes, polyamide resins, and mixtures thereof.

5. The method of claim 4 wherein said water-soluble polyvinyl acetal has a concentration within a range of 5 to 80 wt %.

6. The method of claim 1 wherein said at least one pigment has a concentration in said at least one ink-receiving layer of 1 to 10 wt %.

7. The method of claim 6 wherein said at least one pigment is selected from the group consisting of silica, cationic-modified silica, cationic polymeric binder-treated silica, aluminum oxide, magnesium oxide, magnesium carbonate, calcium carbonate, pseudo-boehmite, barium sulfate, clay, titanium dioxide, gypsum, and mixtures thereof.

8. The method of claim 1 wherein said at least one ink-receiving layer comprises about 5 to 50 wt % of polyvinyl acetal as binder and at least 0.5 to 10 wt % of a silica pigment.

9. The method of claim 8 wherein said water-soluble polyvinyl acetal has a concentration within a range of 5 to 30 wt %.

10. A method for improving at least the light fastness of ink jet photo media comprising a substrate, at least one ink-receiving layer thereon, and, optionally, a top protective coat on the uppermost ink-receiving layer, said at least one ink-receiving layer comprising at least one pigment and at least one binder comprising polyvinyl alcohol, said method comprising at least partially replacing said polyvinyl alcohol in said at least one binder with water-soluble polyvinyl acetal.

11. The method of claim 10 wherein said at least one binder has a concentration in said at least one ink-receiving layer within a range of 9 to 99 wt % and wherein of the total binder concentration, at least 5 wt % of said total binder concentration comprises said water-soluble polyvinyl acetal.

12. The method of claim 11 wherein said at least one binder has said concentration within a range of 80 to 99 wt %.

13. The method of claim 11 wherein said at least one binder comprises less than 100 wt % said polyvinyl acetal and further includes at least one binder selected from the group consisting of polyvinyl alcohol and derivatives thereof, starch, SBR latex, gelatin, alginates, carboxycellulose materials, polyacrylic acid and derivatives thereof, polyvinyl pyrrolidone, casein, polyethylene glycol, polyurethanes, polyamide resins, and mixtures thereof.

14. The method of claim 13 wherein said water-soluble polyvinyl acetal has a concentration within a range of 5 to 80 wt %.

15. The method of claim 10 wherein said at least one pigment has a concentration in said at least one ink-receiving layer of 1 to 10 wt %.

16. The method of claim 15 wherein said at least one pigment is selected from the group consisting of silica, cationic-modified silica, cationic polymeric binder-treated silica, aluminum oxide, magnesium oxide, magnesium carbonate, calcium carbonate, pseudo-boehmite, barium sulfate, clay, titanium dioxide, gypsum, and mixtures thereof.

17. The method of claim 10 wherein said at least one ink-receiving layer comprises about 5 to 50 wt % polyvinyl acetal as binder and at least 0.5 to 10 wt % of a silica pigment.

18. The method of claim 17 wherein said water-soluble polyvinyl acetal has a concentration within a range of 5 to 30 wt %.,
